(19) United States
(12) Patent Application Publication
(10) Pub. No.: US 2014/0342296 A1
(43) Pub. Date: Nov. 20, 2014

(54) HEATER PROOFER CABINET

(71) Applicant: ADMIRAL CRAFT EQUIPMENT CORPORATION, Hicksville, NY (US)

(72) Inventors: RICHARD D. POWERS, MILL NECK, NY (US); RONALD D. POWERS, OLD SAYBROOK, CT (US)

(73) Assignee: ADMIRAL CRAFT EQUIPMENT CORPORATION, HICKSVILLE, NY (US)

(21) Appl. No.: 13/895,017

(22) Filed: May 15, 2013

(51) Int. Cl. F27D 1/18; B23P 19/04

(52) U.S. Cl. CPC F27D 1/18; B23P 19/04
USPC 432/120; 29/525.01; 29/407.09

(57) ABSTRACT

A heater proofer cabinet includes a head cover board secured to left and right side cabinet boards with a fastener and the adhesive. A bottom board is secured to the left and right side cabinet boards with a fastener and the adhesive. A back panel is secured to the left and right side cabinet boards, head cover board and bottom board with a fastener and the adhesive. A heater proofer unit and a wind deflector are positioned so as to be operative within the heater proofer cabinet. A front door is attached to the left side cabinet board or the right side cabinet board.

### BACKGROUND

Heater proofer cabinets may be used as a hot food holding cabinet and/or as a proofing cabinet for commercial kitchens. Proofing may be used, for example, to generate a desired moisture level in the cabinet. The cabinet may include a heat drawer and water pan. Controls for the heat and the humidity may be attached to the cabinet.

### SUMMARY OF THE INVENTION

In one example, a heater proofer cabinet comprising a left side cabinet board and a right side cabinet board secured to doorframe bracing pieces, a head cover board, and a bottom board, with a fastener and an adhesive. A back panel secured to the left and right side cabinet boards, head cover board and bottom board with a fastener and the adhesive. A heater proofer unit and a wind deflector positioned in the cavity defined by the left and right side cabinet boards, the head cover board, the bottom board and the back panel. The wind deflector positioned so as to be operative with the heater proofer unit. A front door secured to the left side cabinet board or the right side cabinet board.

In one example, a method of assembling a heater proofer cabinet. The method comprising securing doorframe bracing pieces, a head cover board, and a bottom board to left and right side cabinet boards using a fastener and an adhesive. The method further comprising securing a back panel to the left and right side cabinet boards, head cover board and bottom board using a fastener and the adhesive, where the left and right side cabinet boards, the head cover board, the bottom board and the back panel define a cavity. The method further comprising securing a heater proofer unit within the cavity, attaching a wind deflector within the cavity so as to be operative with the heater proofer unit, and attaching a front door to the left side cabinet board or the right side cabinet board.

In one example a heater proofer cabinet comprising a left side cabinet board and a right side cabinet board secured to doorframe bracing pieces, a head cover board, and a bottom board, with a fastener and an adhesive. A back panel secured to the left and right side cabinet boards, head cover board and bottom board with the fasteners and the adhesive. A heater proofer unit placed in a cavity defined by the left side cabinet board, the right side cabinet board, the head cover board, the bottom board and the back panel. A wind deflector effective to be operative with the heater proofer unit. Wheels secured to the bottom board, shutter pieces secured to the left or right side cabinet board, and a front door secured to the shutter pieces.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims taken in conjunction with the accompanying drawings. Understanding that these drawings depict only some embodiments in accordance with the disclosure and are therefore not to be considered limiting of its scope, the disclosure will be described with additional specificity and detail by reference to the accompanying drawings in which:

FIG. 1 is a front perspective view of a heater proofer cabinet in accordance with an embodiment of the invention.

FIG. 2 is a front perspective view illustrating assembly of a heater proofer cabinet.

FIG. 3 is a top perspective view illustrating assembly of a heater proofer cabinet.

FIG. 4 is a bottom perspective view illustrating assembly of a heater proofer cabinet.

FIG. 5 is a bottom perspective view illustrating assembly of a heater proofer cabinet.

FIG. 6 is a front perspective view illustrating assembly of a heater proofer cabinet.

FIG. 7 is a back perspective view illustrating assembly of a heater proofer cabinet.

FIG. 8 is a front perspective view illustrating assembly of a heater proofer cabinet.

FIG. 9 is a side perspective view illustrating assembly of a heater proofer cabinet.

FIG. 10 is a side perspective view illustrating assembly of a heater proofer cabinet.

FIG. 11 is a front perspective view illustrating assembly of a heater proofer cabinet.

FIG. 12 is a front perspective view of a heater proofer cabinet in accordance with an embodiment of the invention.

### DETAILED DESCRIPTION

In the following detailed description, reference is made to the accompanying drawings which form a part thereof. In the drawings, similar symbols typically identify similar components unless context indicates otherwise. The illustrative embodiments described in the detailed description, drawings and claims are not meant to be limiting. Other embodiments may be utilized and other changes may be made without departing from the spirit or scope of the subject matter presented herein. It will be readily understood that the aspects of the present disclosure as generally described herein and as illustrated in the accompanying figures can be arranged, substituted, combined, separated and/or designed in a wide variety of different configurations all of which are explicitly contemplated herein.

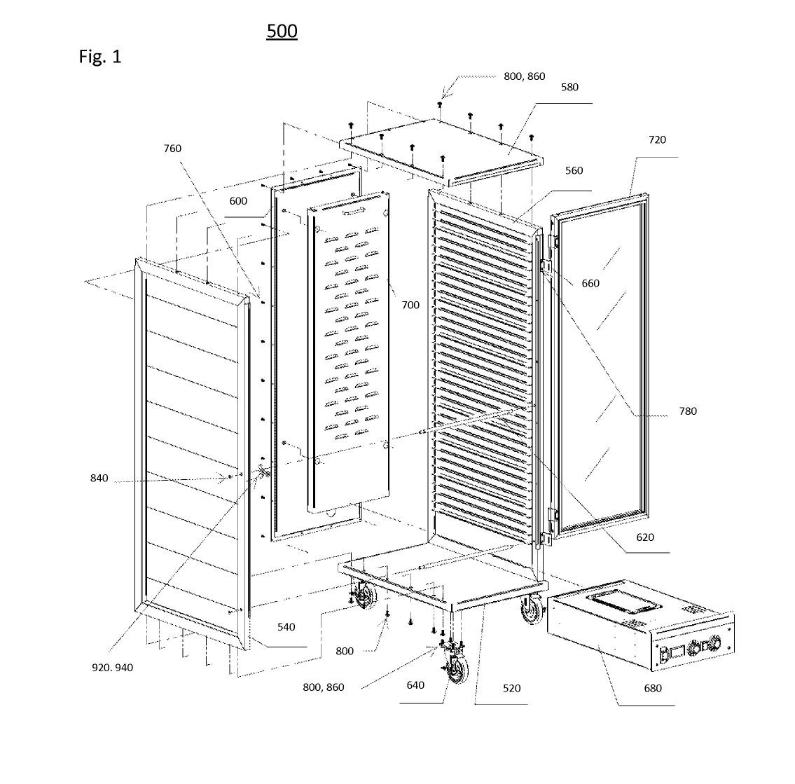

FIG. 1 is a front perspective of a heater proofer cabinet in accordance with an embodiment of the invention. A labelling of some of the parts of the heater proofer assembly will now be described. A heater proofer cabinet 500 includes a bottom board 520, a left side cabinet board 540, a right side cabinet board 560, a head cover 580, and a back panel 600. Heater proofer cabinet 500 may also include doorframe bracing pieces 620, shutter pieces 660, universal wheels 640, a heater unit 680, a wind deflector 700 and a transparent door 720.

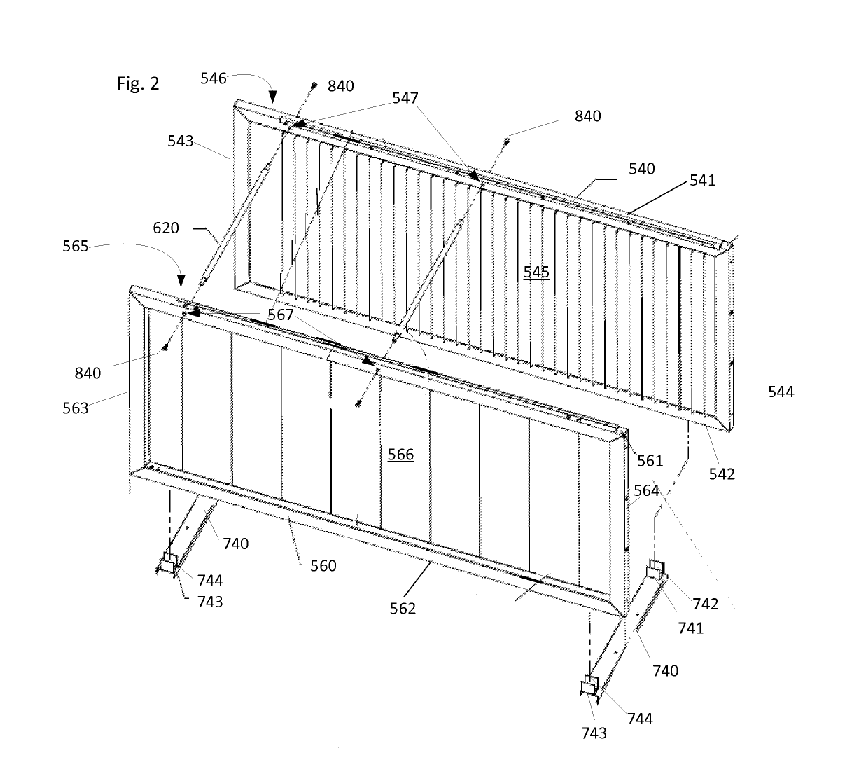

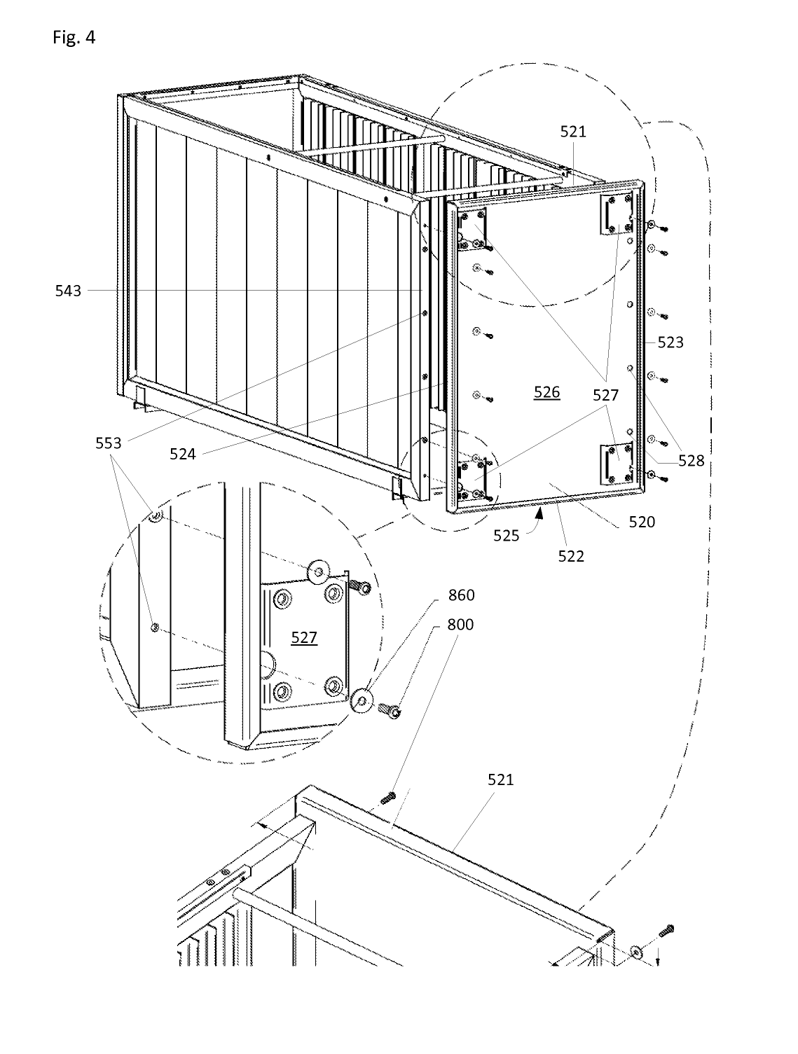

Focusing also on FIG. 2, left side cabinet board 540 includes a first edge 541, a second edge 542, a third edge 543, and a fourth edge 544. First edge 541 includes a small angle iron and walls that define holes 547 for doorframe bracing pieces 620. Second edge 542 defines holes for back panel 600. Third edge 543 defines holes 553 (FIG. 4) for bottom board 520. Fourth edge 544 defines holes for head cover 580. Left side cabinet board 540 further includes a first side 545 and a second side 546. First side 545 includes a slotted convex surface and second side 546 includes a flat concave surface.

Right side cabinet board 560 includes a first edge 561, a second edge 562, a third edge 563, and a fourth edge 564. First edge 561 includes a small angle iron and walls that define holes 547 (FIG. 2) for doorframe bracing pieces 620. First edge 561 also defines holes 568 (FIG. 8) for shutter pieces 660. Second edge 562 defines holes for back panel 600. Third edge 563 defines holes for bottom board 520. Fourth edge 564 defines holes for head cover 580. Right side cabinet board 560 further includes a first side 565 and a second side 566. First side 565 includes a slotted convex surface and second side 566 includes a flat concave surface.

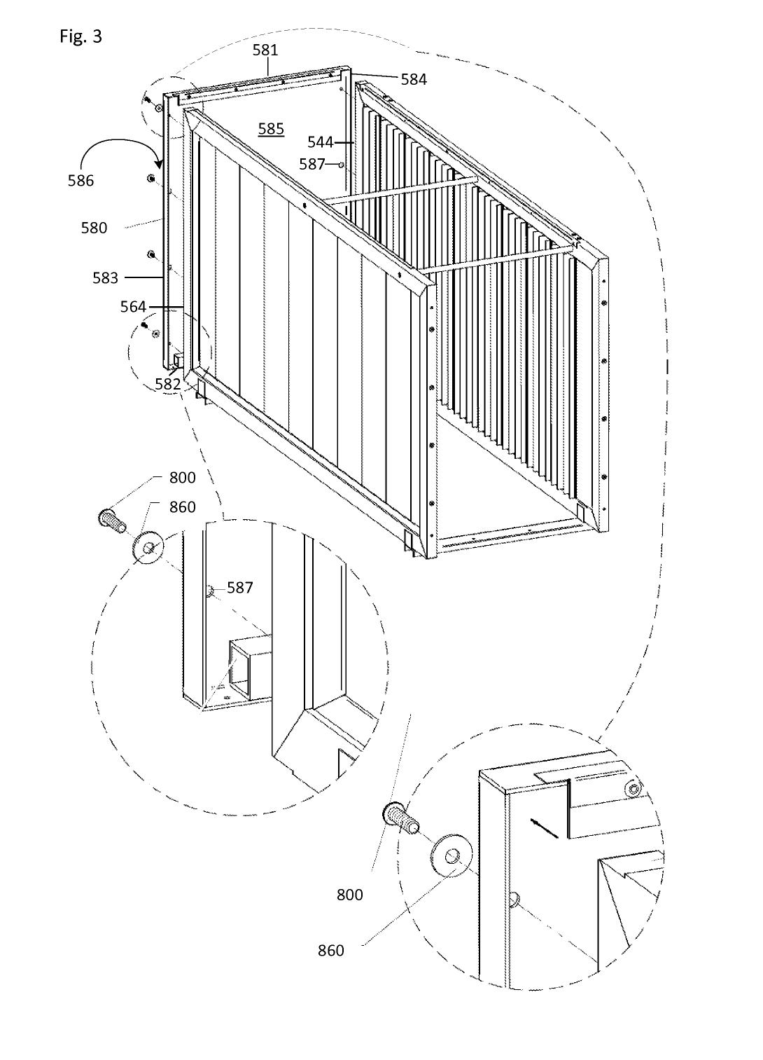

Referring to FIG. 3, head cover 580 further includes a first side 585, a second side 586 and holes 587 for securing. Referring to FIG. 4, bottom board 520 includes a first edge 521, a second edge 522, a third edge 523, and a fourth edge 524. Bottom board 520 further includes a first side 525, a second side 526 and holes 528 for securing. Second side 526 has four universal wheel mounts 527. Head cover 580 includes a first edge 581, a second edge 582, a third edge 583, and a fourth edge 584.

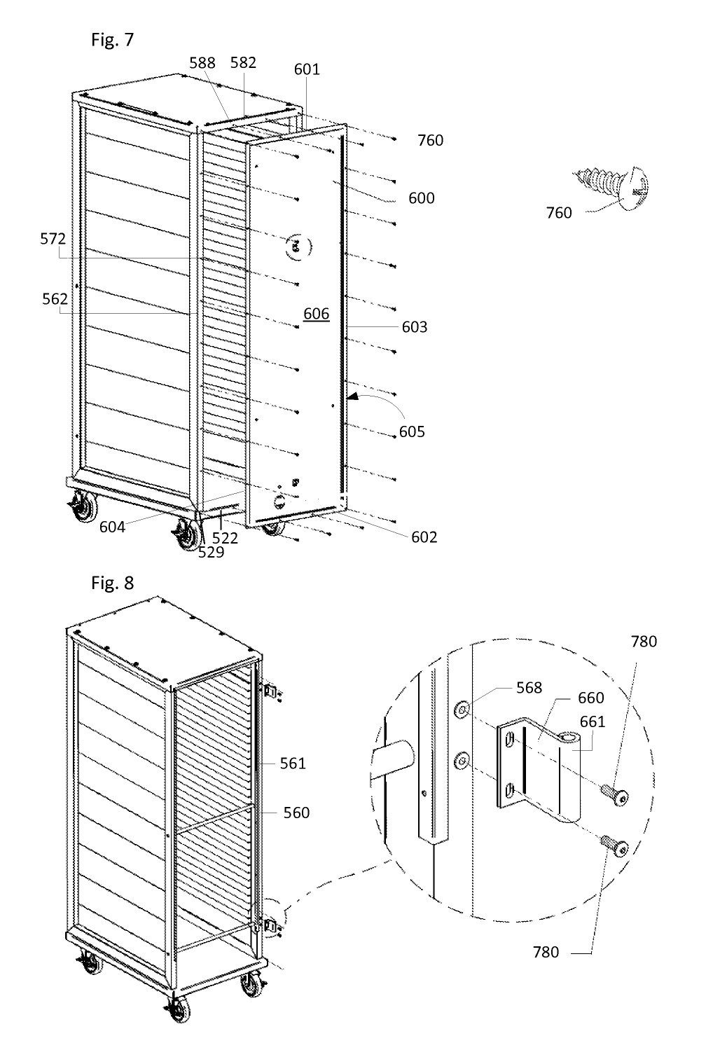

Referring to FIGS. 7-10, back panel 600 includes a first edge 601, a second edge 602, a third edge 603, and a fourth edge 604. Back panel 600 further includes a first side 605, a second side 606, bolt hole 607, and cord hole 608 for securing. First side 605 includes four bolts 609 for wind deflector 700.

Wind deflector 700 includes a first side 702 and a second side 703. First side 702 includes a wind deflector handle 701 and four wind deflector mounting holes 704. Second side 703 includes wind deflector mounting slots 705. Heater 680 includes a bolt 681 and a cord 682.

Referring again to FIG. 2, assembly of heater proofer cabinet 500 will now be explained. Installation auxiliary parts 740 include guide flanges 741 and 743 which, in turn, define cavities 742 and 744. Assembly of heater proofer cabinet 500 begins by placing two installation auxiliary parts 740 on a flat level surface parallel to each other and approximately 54 inches apart. First and second side guide flanges 741 and 743 should be extending up.

Second edge 542 of left side cabinet board 540 should be inserted into both of the cavities 742 of installation auxiliary parts 740. First edge 541 of left side cabinet board 540 should be upward, first side 545 should face inward and second side 546 should face outward.

Second edge 562 of the right side cabinet board 560 should be inserted into both of the cavities 744 of installation auxiliary parts 704. First edge 561 of right side cabinet board 560 should be upward, first side 565 should face inward toward left side cabinet board 540, and second side 566 should face outward away from the left side cabinet board 540. The edges 544 and 564 of both side cabinet boards 540 and 560 are then lined up.

Each doorframe bracing piece 620 inserts into one hole 547 in edge 541 and the corresponding hole 567 in edge 561. The doorframe bracing pieces 620 are secured to left side cabinet board 540 and right side cabinet board 560 with a fastener 840. Fastener 840 may be counter sunk head screws coated with a threadlocker adhesive such as LOCTITE threadlocker.

Fasteners 840 may be tightened with a hexagon wrench. Fasteners 840 inserted into holes 547 should be turned until the screw head just makes contact with the surface of side 546 of left side cabinet board 540. Fasteners 840 inserted into holes 567 should be turned until the screw head just makes contact with the surface of side 566 of right side cabinet board 560.

Referring to FIG. 3, head cover 580 is aligned to the fourth edge 544 of left side cabinet board 540 and fourth edge 564 of right side cabinet board 560. First edge 581 of head cover 580 should face upward and first side 585 faces toward fourth edges 544 and 564 of left and right side cabinet boards 540, 560 respectively. Holes 587 in head cover 580 should align to holes in edge 544 and holes 574 in edge 564.

Head cover 580 is secured to left side cabinet board 540 and right side cabinet board 560 at the aligned holes with fasteners 800 and washers 860. Fasteners 800 may be socket head screws coated with a threadlocker adhesive such as LOCTITE threadlocker and washers 860 may be flat washers. Fasteners may be tightened with a hexagon wrench. The fasteners should be turned until the screw head and washer just make contact with the surface of side 586 of head cover 580.

Referring to FIG. 4, bottom board 520 is aligned to third edge 543 of left side cabinet board 540 and third edge 563 of right side cabinet board 560. Holes 528 in the bottom board 520 align to holes 553 in edge 543 and to holes in edge 563.

Bottom board 520 is secured to left side cabinet board 540 and right side cabinet board 560 at the aligned holes with fasteners 800 and washers 860. Fasteners 800 may be socket head screws coated with a threadlocker adhesive such as LOCTITE threadlocker and washers 860 may be flat washers. Fasteners may be tightened with a hexagon wrench. The fasteners should be turned until the screw head and washer just make contact with the surface of side 526 of bottom board 520.

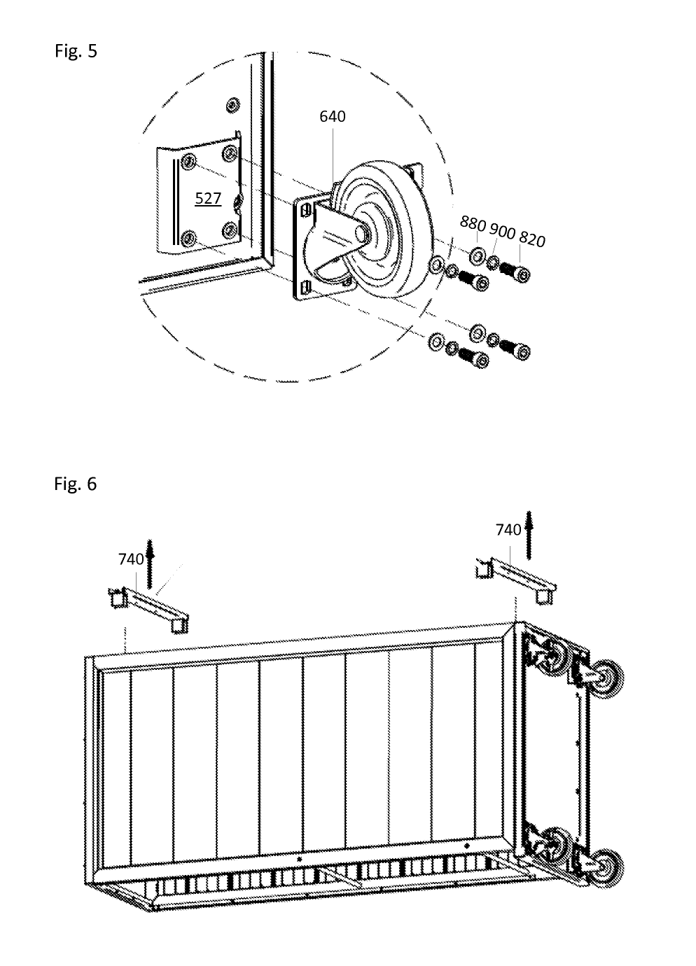

Referring to FIG. 5, each universal wheel 640 is aligned to a wheel mount 527 on bottom board 520. Each wheel 640 is attached with fasteners 820 and washers 900 and 880. Fasteners 820 may be hex head screws coated with a threadlocker adhesive such as LOCTITE threadlocker. Washers 880 may be flat washers and washers 900 may be spring washers. The fasteners may be tightened with a hexagon wrench. Fasteners 820 should be fully tightened.

Referring to FIG. 6, partially assembled heat proofer cabinet 500 is carefully rotated onto a side panel and then rotated over a second time so that installation auxiliary parts 740 are on top of the assembly. Installation auxiliary parts 740 are then removed.

Referring to FIG. 7, side 605 of back panel 600 should face inward towards side cabinet boards 540 and 560, head cover 580 and bottom board 520. Edge 601 is aligned to edge 582 of head cover 580, edge 602 is aligned to edge 522 of bottom board 520, edge 603 is aligned to edge 542 of left side cabinet board 540 and edge 604 is aligned to edge 562 of right side cabinet board 560. Holes 601 in back panel 600 align to holes 588 in edge 582, to holes 529 in edge 522, to holes 552 in edge 542 and to holes in edge 562.

Back panel 600 is secured to side cabinet boards 540 and 560, head cover 580 and bottom board 520 at the aligned holes with fasteners 760. Fasteners 760 may be tapping screws coated with a threadlocker adhesive such as LOCTITE threadlocker. The fasteners 760 may be tightened with a crosshead screwdriver. The fasteners should only be turned until the screw head just makes contact with the surface 606 of pack panel 600.

Left side cabinet board 540, right side cabinet board 560, head cover 580, bottom board 520 and back panel 600 secured together make up the frame of heater proofer cabinet 500 and define a cavity within. Fasteners 760, 800, and 840 should now be fully tightened. Referring to FIG. 8, partially assembled heater proofer cabinet 500 is positioned upright with universal wheels 640 on the floor and supporting the other pieces.

Shutter pieces 660 are aligned to edge 561 of right side cabinet board 560 at holes 568. Hinge 661 of the shutter pieces 660 should face towards side 566 and away from side 565. Shutter pieces 660 are secured to right side cabinet board 560 at holes 568 by fasteners 780. Fasteners 780 may be pan head screws coated with a threadlocker adhesive, such as LOCTITE threadlocker. The fasteners may be tightened with a hexagon wrench. Fasteners 780 should be fully tightened.

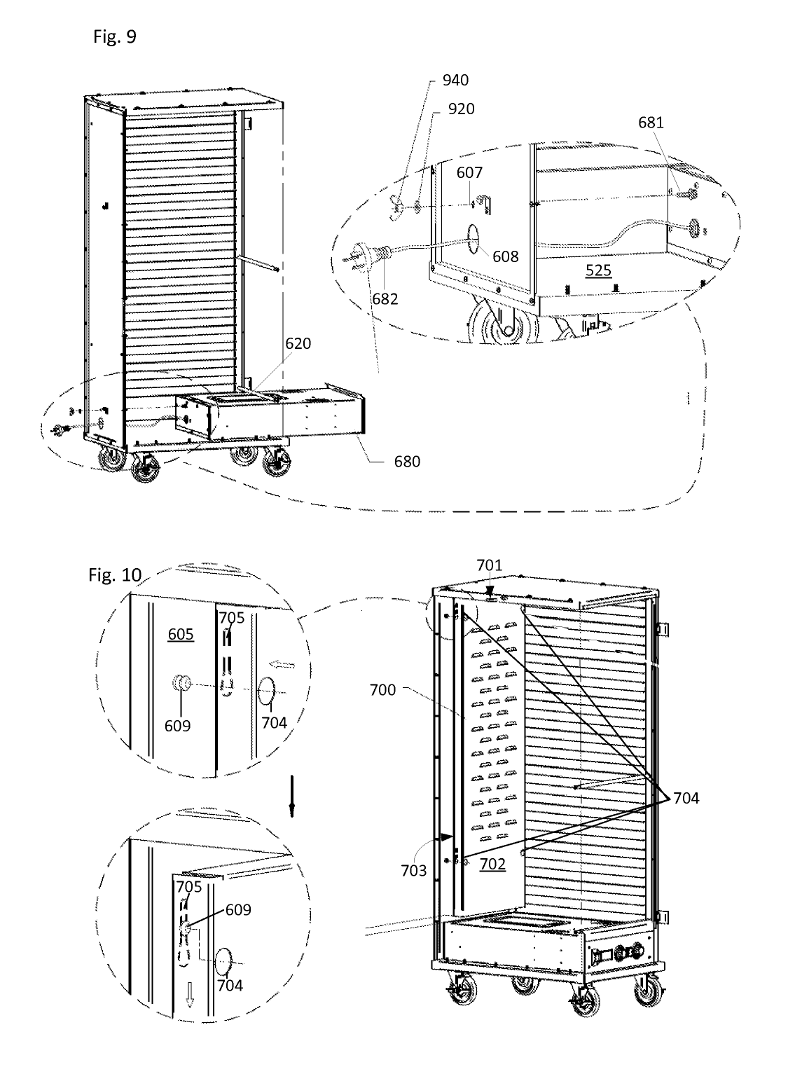

Referring to FIG. 9, heater proofer unit 680 is slid into the space at the bottom of cabinet 500 above bottom board 520 and below lower doorframe bracing piece 620. Heater proofer unit 680 sits on side 525 of bottom board 520 with bolt 681 and cord 682 extending toward back panel 600. Cord 682 should be pulled through cord hole 608 in back panel 600 as heater proofer unit 680 is slid in until bolt 681 is through hole 607 in back panel 600.

Heater proofer unit 680 is secured to back panel 600 by fastener 940 and washer 920. Fastener 940 may be a butterfly nut coated with a threadlocker adhesive such as LOCTITE threadlocker and washer 920 may be a flat washer. Fastener 940 should be fully tightened.

Referring to FIG. 10, side 703 of wind deflector 700 aligns to side 605 of back panel 600 with wind deflector handle 701 toward a top of cabinet 500 and facing towards side 585 of head cover 580. Wind deflector 700 is attached to back panel 600 by placing mounting slots 705 in side 703 over bolts 609 on side 605 and sliding wind deflector 700 down until bolts 609 reach the apex of slots 705. Holes 704 in side 702 provide visibility to ensure wind deflector 700 is properly attached to back panel 600.

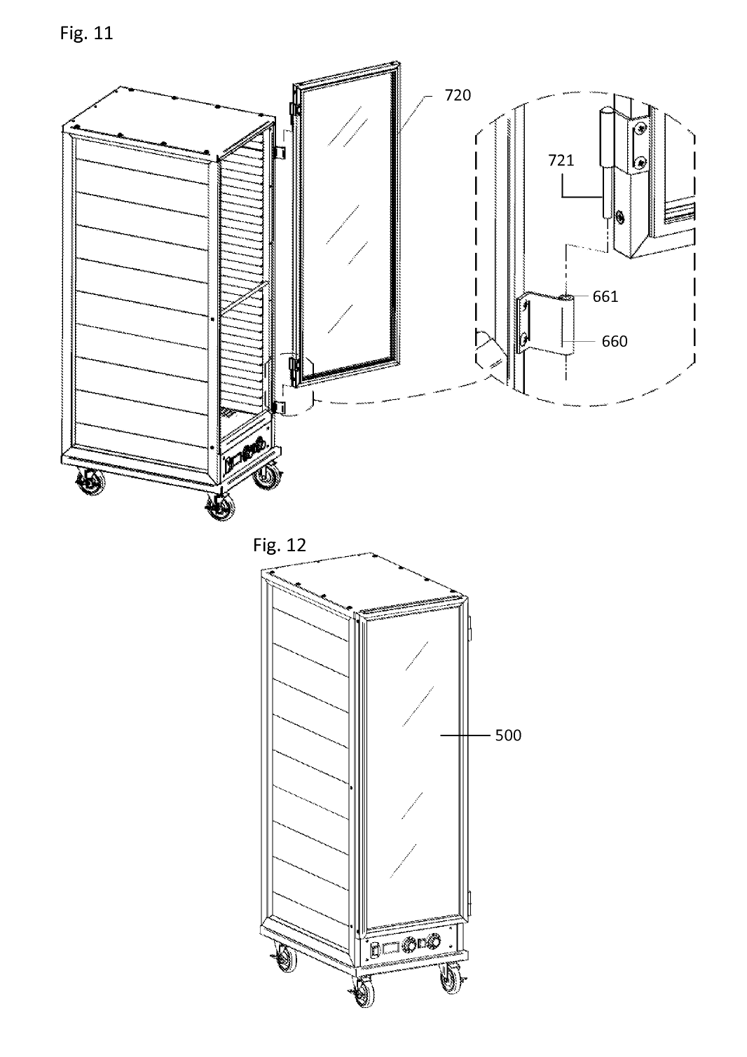

Referring to FIG. 11, hinge prongs 721 on transparent door 720 are inserted into hinges 661 of shutter pieces 660 from above so that the door can swing open and forms an air tight seal when closed. Heater proofer cabinet 500 is fully assembled in FIG. 12.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A heater proofer cabinet comprising:
a left side cabinet board secured to a doorframe bracing piece with a first fastener and an adhesive;
a right side cabinet board secured to the doorframe bracing piece with a second fastener and the adhesive;
a head cover board secured to the left and right side cabinet boards with a third fastener and an adhesive;
a bottom board secured to the left and right side cabinet boards with a fourth fastener and the adhesive;
a back panel secured to the left and right side cabinet boards, head cover board and bottom board with a fifth fastener and the adhesive;
the left side cabinet board, the right side cabinet board, the head cover board, the bottom board and the back panel arranged to define a cavity;
a heater proofer unit in the cavity; and
a wind deflector in the cavity positioned so as to be operative with the heater proofer unit; and
a front door secured to the left side cabinet board or the right side cabinet board.

2. The cabinet of claim 1, wherein the fasteners are coated with a threadlocker adhesive.

3. The cabinet of claim 1, further comprising wheels secured with a fourth fastener and the adhesive to the bottom board.

4. The cabinet of claim 3, wherein the fasteners are coated with a threadlocker adhesive.

5. The cabinet of claim 1, further comprising shutter pieces secured to the right side cabinet board.

6. The cabinet of claim 5, wherein the fasteners are coated with a threadlocker adhesive.

7. The cabinet of claim 1, wherein the front door is a transparent door.

8. A method of assembling a heater proofer cabinet, the method comprising:
securing a left-side cabinet board to doorframe bracing pieces using a first fastener and an adhesive;
securing a right-side cabinet board to doorframe bracing pieces using a second fastener and the adhesive;
securing a head cover board to left and right side cabinet boards using a third fastener and an adhesive;
securing a bottom board to the left and right side cabinet boards using a fourth fastener and the adhesive;
securing a back panel to the left and right side cabinet boards, head cover board and bottom board using a fifth fastener and the adhesive, where the left side cabinet board, the right side cabinet board, the head cover board, the bottom board and the back panel define a cavity;
securing a heater proofer unit within the cavity;
attaching a wind deflector within the cavity positioned so as to be operative with the heater proofer unit; and
attaching a front door to the left side cabinet board or the right side cabinet board.

9. The method of claim 8, wherein the securing is performed with fasteners coated with a threadlocker adhesive.

10. The method of claim 8, further comprising securing wheels to the bottom board with fasteners coated with an adhesive.

11. The method of claim 10, wherein the securing is done by fasteners coated with a threadlocker adhesive.

12. The method of claim 8, further comprising securing shutter pieces to the right side cabinet board with fasteners coated with an adhesive.

13. The method of claim 12, wherein the securing is performed by fasteners coated with a threadlocker adhesive.

14. The method of claim 13, further comprising attaching the front door to the shutter pieces.

15. The method of claim 8, wherein the front door is a transparent door.

16. The method of claim 8, wherein the wind deflector is attached to the back panel.

17. The method of claim 8, wherein the heater proofer unit is secured to the back panel by fasteners coated in an adhesive.

18. The method of claim 8 wherein installation auxiliary parts are used to facilitate the aligning and securing of;
a left-side cabinet board to doorframe bracing pieces;
a right-side cabinet board to doorframe bracing pieces;
a head cover board to the left and right-side cabinet boards;
a bottom board to the left and right-side cabinets boards.

19. A heater proofer cabinet comprising:
fasteners;
an adhesive;
a left side cabinet board;
a right side cabinet board;
doorframe bracing pieces effective to be secured to the left and right side cabinet boards with the fasteners and the adhesive;
a head cover board effective to be secured to the left and right side cabinet boards with the fasteners and the adhesive;
a bottom board effective to be secured to the left and right side cabinet boards with the fasteners and the adhesive;
a back panel secured to the left and right side cabinet boards, head cover board and bottom board with the fasteners and the adhesive;
a heater proofer unit effective to be placed in a cavity defined by the left side cabinet board, the right side cabinet board, the head cover board, the bottom board and the back panel;
a wind deflector effective to be operative with the heater proofer unit;
wheels effective to be secured to the bottom board;
shutter pieces effective to be secured to the left or right side cabinet board; and
a front door effective to be secured to the shutter pieces.

20. The cabinet of claim 19, wherein the fasteners are coated with a threadlocker adhesive.
